(19) United States
(12) Patent Application Publication
(10) Pub. No.: US 2021/0363815 A1
(43) Pub. Date: Nov. 25, 2021

(54) CONNECTING METHOD

(71) Applicant: THOMAS INVESTMENT HOLDINGS LIMITED, Stafford Staffordshire (GB)

(72) Inventor: David John THOMAS, Stafford Staffordshire (GB)

(21) Appl. No.: 16/967,946

(22) PCT Filed: Feb. 5, 2019
(86) PCT No.: PCT/GB2019/050307

§ 371 Date: Aug. 6, 2020

(30) Foreign Application Priority Data
Feb. 6, 2018 (GB) 1801889.5
Apr. 12, 2018 (GB) 1806044.2

(51) Int. Cl. E06B 3/96; E06B 3/964; E06B 3/968; E06B 3/984

(52) U.S. Cl. CPC E06B 3/9608; E06B 3/9845; E06B 3/9682; E06B 3/9646

(57) ABSTRACT

A method of connecting hollow elongate members 12 which may be window frame members. The method comprising locating a plastics material insert 16 extending outwardly for a short distance from each hollow member 12, heating the inserts, and bringing the hollow members together such that the heated inserts 16 fuse together to connect the hollow members 12.

This invention concerns a connecting method, a method of forming a frame and especially a window frame, a frame and particularly a window frame.

In frames used for instance in building and particularly window frames, it is generally required to join together lengths of material such as frame members, typically at right angles to each other. With for instance hollow plastic window frame profiles, these are often welded together. This though requires extensive cleaning or finishing of the joint following formation, to provide a clean finish without for instance a raised rim of material which melted during the joining.

When providing one or more transoms and/or mullions in plastic window frames, it is conventional to provide an “arrow head” connection with inclined faces to provide a sufficiently strong connection. This though provides an appearance which differs from an equivalent connection in a wooden frame, where the two parts would be interconnected perpendicularly with no arrow head or other such formation.

With for example aluminium frame members, these are usually joined together by a mechanical joint system, or by crimping the corners together. Air and waterflow may occur through such joints which will generally be undesirable.

According to a first aspect of the invention there is provided a method of connecting two members, at least one of which is hollow, the method comprising locating an insert in a hollow one of the members and extending thereoutof to interconnect to the other of the members.

A mounting member may be provided on the other of the members, to which the insert may join to interconnect the members.

According to a further aspect of the invention there is provided a method of connecting two hollow members, the method comprising locating an insert extending between the hollow members to interconnect the hollow members.

The insert may be profiled, and may comprise a first part locatable in a first one of the hollow members, and a second part inclined relative to the first part and locatable in a second of the hollow members, so as to connect the first and second hollow members inclined relative to each other. The insert may be substantially L shaped so as to perpendicularly interconnect the hollow members.

Separate inserts may be locatable respectively in the interior of each hollow member, and the inserts joined together to interconnect the hollow members.

In one aspect of the invention the respective inserts are adhered to each other to interconnect the hollow members.

In a further aspect of the invention the respective inserts are fused together by heating the inserts.

The inserts may be welded together.

The inserts may be heated in the two hollow members, and subsequently brought together with the inserts still hot such that they fuse together.

The hollow members may comprise lengths of profiled sections, which may be formed by extrusion.

The inserts may be profiled to fit within the hollow members and may provide a friction fit therein. Formations may be provided on the insert and/or hollow members to retain the insert in the interior of the hollow members.

The profiled section may comprise a plurality of chambers. The inserts may comprise a base which locates at least initially outside of the hollow member and a plurality of projections extending from the base, which projections locate in the respective chambers in the hollow member.

Edges of the insert may be chamfered or otherwise profiled to avoid overlapping edges of the hollow members.

Initially the inserts may protrude from the hollow members, and the hollow members may be bought together to immediately adjacent each other such that the inserts are substantially not visible.

The hollow members may be elongate and may extend perpendicularly to each other. Ends of the elongate members may be inclined to provide a mitered joint therebetween, and the ends of the inserts may also be inclined.

In one configuration the hollow members are elongate, and extend perpendicularly to each other with a first one of the hollow members being connected at an end thereof, to a location on a second one of the hollow members intermediate the ends thereof.

An opening may be cut in the second hollow member to enable an insert to be located therein, to join to an insert located in the end of the first hollow member.

The end of the first hollow member, and/or a side part of the second hollow member, may be cut so as to provide a substantially flush connection between the first and second hollow members,

According to a yet further aspect of the invention there is provided a method of connecting three hollow members, each with a respective insert in the interior of an end of the member so as to be joinable to the inserts in the other hollow members, with first and second hollow members being connectable together coaxially end to end, and a third hollow member being connectable perpendicularly to the first and second hollow member, across the connection between the first and second hollow members.

Openings may be provided in the sides of the first and second hollow members to enable the inserts in the first and second hollow members to join to the insert in the third members.

The first and second hollow members may be handed so as to have different profiles on each side, and the first and second hollow members may be aligned to be opposite handed to each other.

The hollow members may be formed by forming a recess in at least an end part of a solid member.

The hollow members may be made of a plastics material and may be made of UPVC. Alternatively, the hollow members may be made of metal and may be made for instance of aluminium. As a further alternative the hollow members may be made of wood.

The inserts may be made of a plastics material and may be made of PVC.

According to a still further aspect of the invention there is provided a method of forming a frame, the method comprising connecting together a plurality of hollow frame members using a method according to any of the preceding twenty four paragraphs.

The invention still further provides a method of forming a frame, the method being according to any of said preceding twenty four paragraphs.

The invention yet further provides a frame made by a method according to any of said preceding twenty four paragraphs.

The invention yet further provides a window frame made by a method according to any of said preceding twenty four paragraphs.

The invention moreover provides an insert usable in a method according to any of said preceding twenty four paragraphs.

Embodiments of the present invention will now be described by way of example only and with reference to the accompanying drawings, in which:—

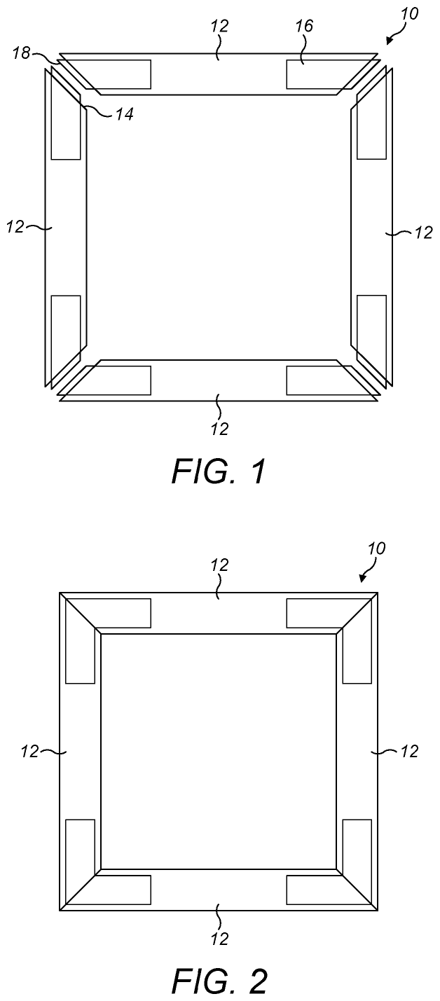

FIG. 1 is a diagrammatic plan view of a frame being made by a method according to the present invention;

FIG. 2 is a similar view to FIG. 1 but with the frame complete;

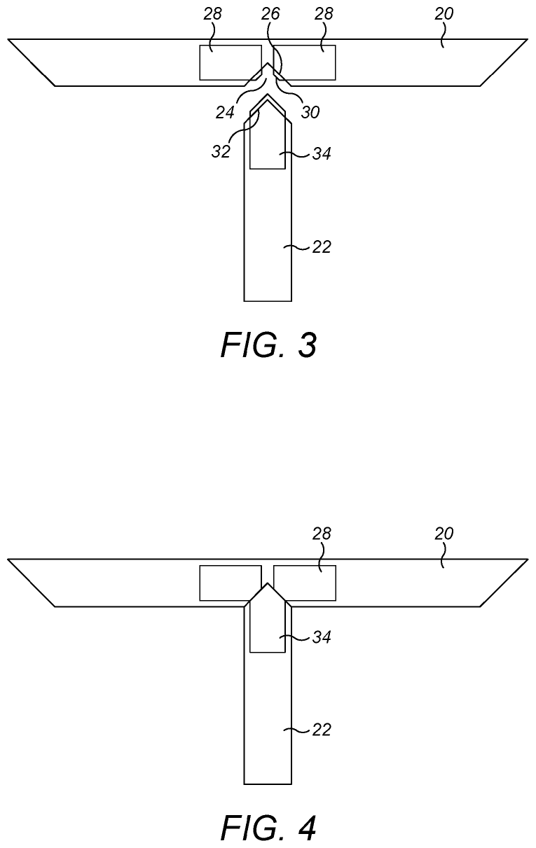

FIG. 3 is a diagrammatic plan view showing two elongate members being connected by a method according to the invention;

FIG. 4 shows the elongate members of FIG. 3 following interconnection;

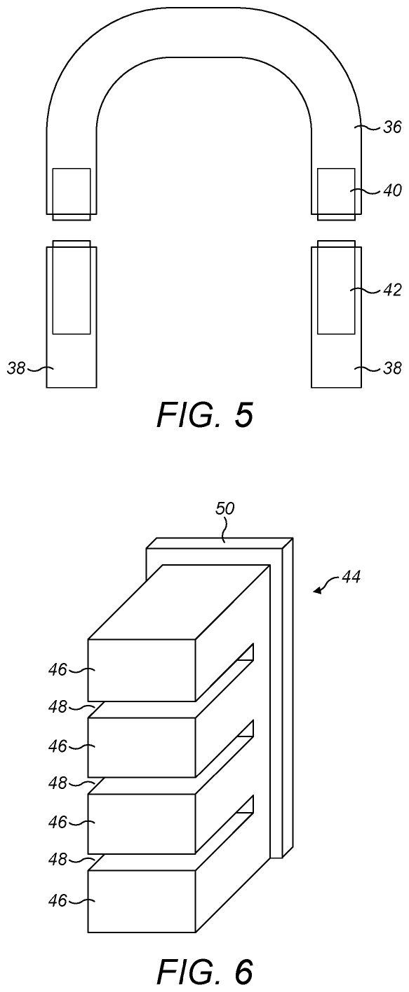

FIG. 5 is a diagrammatic plan view showing two further members being interconnected;

FIG. 6 is a diagrammatic perspective view of an insert usable in a method according to the invention;

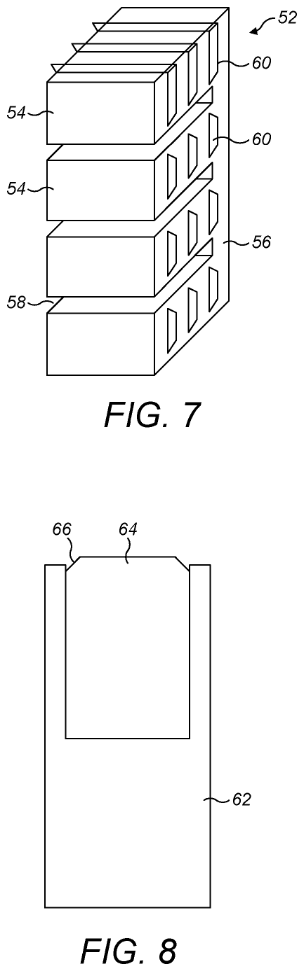

FIG. 7 is a similar view to FIG. 6 of a further insert;

FIG. 8 is a diagrammatic sectional plan view of an item to be connected by a method according to the invention;

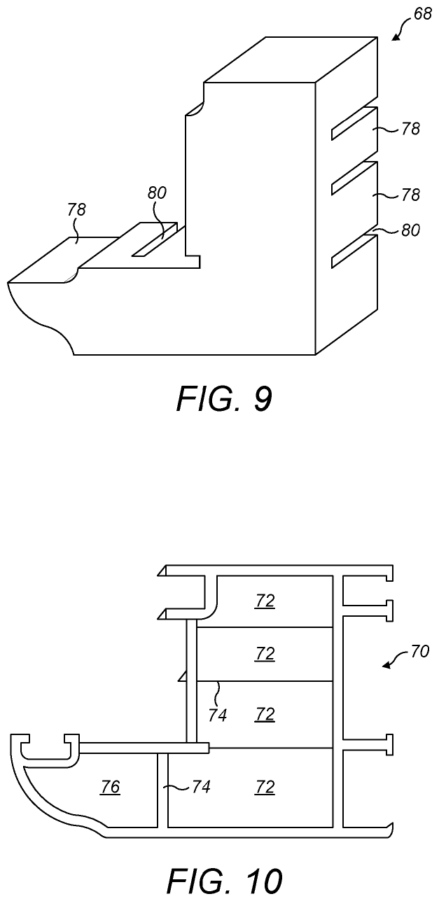

FIG. 9 is a perspective side view of an insert usable in a method according to the invention;

FIG. 10 is a diagrammatic end view of an elongate member with which the insert of FIG. 9 can be used;

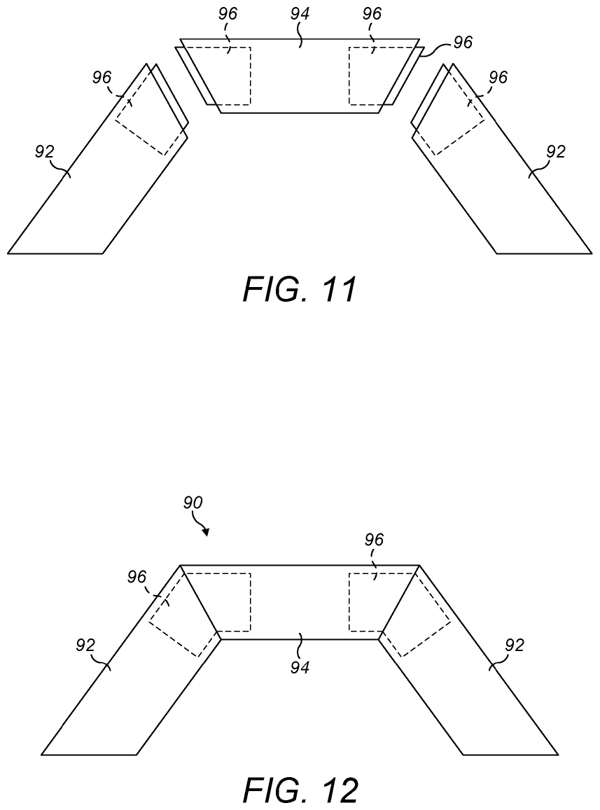

FIG. 11 is a diagrammatic plan view of part of a further frame being made by a method according to the present invention;

FIG. 12 is a similar view to FIG. 11 but with the frame complete;

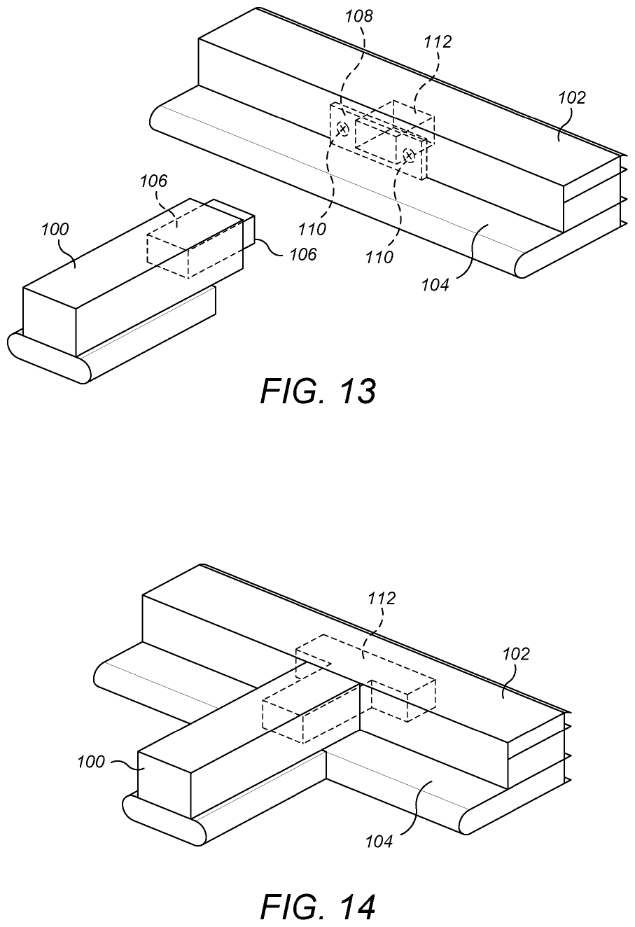

FIG. 13 is a diagrammatic perspective view of part of a still further frame being made by a method according to the present invention;

FIG. 14 is a similar to view FIG. 13 but with the frame complete;

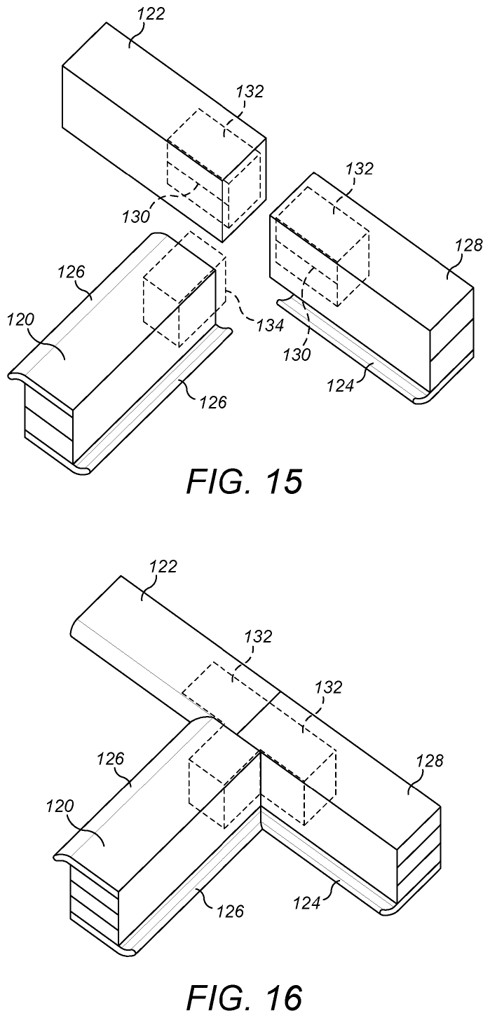

FIG. 15 is a diagrammatic perspective view of a yet further frame being made by a method according to the present invention; and

FIG. 16 is a similar view to FIG. 15 but with the frame complete.

FIGS. 1 and 2 diagrammatically show a square window frame 10 comprising four hollow elongate members 12 which could be in the form of lengths of hollow plastics material profile, or aluminium profile. The ends 14 of the elongate members 12 are inclined at 45° so as to provide a mitered connection with an adjacent perpendicular elongate hollow member 12.

An insert 16 is provided in each end 14 of each elongate member 12, and is a friction fit therein and extends outwardly therefrom for a short distance. The ends 18 of the inserts 16 also are inclined at 45°. The inserts 16 may be made of a thermo forming plastics material such as PVC.

In forming the frame 10, the protruding ends 18 of the inserts 16 are heated, for example by placing a heated plate between the inserts 16 on adjacent perpendicular elongate members 12 to heat the plastics material until it is pliable. The adjacent elongate members 12 are then brought together such that they contact each other or are immediately adjacent each other. The respective still hot inserts 16 are thus brought together, and will be welded together.

This therefore provides a strong connection between the elongate members 12, but which does not affect the external appearance of the join therebetween, and thus no further processing or cleaning is required.

FIGS. 3 and 4 show a join between two elongate members 20, 22, part way along the length of a one of the members 20, as could be provided within a window frame, for instance when mounting a mullion or transom extending across a window frame. In this instance a cut out 24 is provided in the side of the member 20 intermediate its length, with two faces 26 at 45° to the longitudinal direction, and hence perpendicular to each other. Two inserts 28 are provided within the elongate member 20 with inclined faces 30 corresponding to the inclined faces 24 of the elongate member 20, and again protruding a short distance thereoutof.

The elongate member 22 being joined to the number 20 has a pointed end with side faces 32 extending at 45° to the longitudinal direction. Again, a similarly profiled insert 34 is provided in the elongate member 22 and extends thereoutof for a short distance.

In forming the connection, the inserts 28, 34 are again heated using a correspondingly shaped heated plate. The elongate members 20, 22 and hence still hot inserts 28, 34 are then brought together for interconnection, again providing clean edges, as shown in FIG. 4.

FIG. 5 shows an n shaped elongate member 36 being interconnected to two elongate members 38 extending from stems of the n. In this instance straight edges are provided on the elongate members 36, 38 with respective inserts 40, 42 with straight faces located therein and extending a short distance thereoutof. Again, the elongate members 36, 38 can be interconnected by heating the inserts 40, 42 and then bringing the elongate members 36, 38 together to weld together the inserts 40, 42.

FIG. 6 shows a profiled insert 44 for location in the end of a profiled hollow elongate member (not shown), which hollow member would have four chambers located one above each other. As can be seen the insert 44 has four projections 46 one above each other, formed by cuts 48 therebetween, and a flange 50 at one end interconnecting the projections 46. In use the insert would be located in the hollow member with the projections 46 located therein and the flange 50 extending outwardly therefrom. This hollow member could be joined to a hollow member with a similar insert extending outwardly therefrom, and the elongate members could be brought together such that they lie against or substantially adjacent each other.

FIG. 7 shows a generally similar insert 52 to that shown in FIG. 6, but in this instance no flange is provided, and the projections 54 are just interconnected at one end 56 where the cuts 58 end. Ribs 60 are provided on the outside of the projections 54 so as to engage against the insides of an elongate member to retain the insert within the elongate member in a friction fit. In use the insert 52 which will be of a flexible material could be tapped into the interior of the elongate member and then will remain therein by friction.

FIG. 8 diagrammatically shows a hollow elongate member 62 with an insert 64 therein which extends for a short distance thereoutof. As can be seen edges 66 of the insert 64 have been chamfered to avoid the insert and particularly when heated and pliable, engaging between edges of the elongate members.

FIG. 9 shows a further profiled insert usable with an elongate member 70 as shown in FIG. 10. The elongate member 70 has a profile comprising four chambers 72 one above each other, separated by webs 74, and a side chamber 76 adjacent the lowermost of the four chambers 72. The insert 68 comprises five correspondingly shaped projections 78 separated by cuts 80 which can locate the webs 74. The insert 68 is a friction fit within the elongate member 70 so as to be retained therein.

FIG. 11 and FIG. 12 show part of a frame 90 for a bay cill for instance in a bay window. The frame 90 comprises three parts, two 92 at each end and a mid-part 94. The ends of the parts 92, 94 are inclined to provide the profile of the cill. Inserts 96 are provided at each end of the mid-part 94 and at one end of the end parts 92, the inserts also having inclined ends. The parts 92, 94 can be mounted together in a similar manner as described above, by heating the inserts 96, and causing them to fuse together to provide the arrangement shown in FIG. 12.

FIGS. 13 and 14 show for instance a transom or mullion 100 being mounted to a part 102 of a frame, intermediate its length. In this instance the end of the transom/mullion 100 part has been profiled as to provide a flush fit against the frame part 102, including for instance the bead 104. An appropriately profiled insert 106 is provided in the end of the transom/mullion part 100 extending a short distance thereoutof.

FIG. 13 shows two possible mounting arrangements. In one a relatively thin strip 108 of material of the same type as the insert 106 is mounted by two screws 110 to a side of the frame part 102. This strip 108 can be mounted to the insert 106 in a similar manner to that described above.

In the second arrangement, an insert 112 is located within the side frame part 102 and extending from an opening therein so as to again be joinable to the insert in the transom/mullion part 100. FIG. 14 show the second arrangement once the frame parts 100, 102 have been joined.

FIGS. 15 and 16 show a further arrangement for instance for mounting a mullion/transom part 120 to a part 122 of the frame, where the bead 124 swaps sides on the frame, for instance to accommodate an inwardly opening part of the window frame. The transom/mullion part 120 has a bead 126 on each side but respectively on an upper or lower part of the part 120. In this instance the transom/mullion part 120 has a substantially flat end for mounting to the side of the frame part 122.

The side of the frame is formed by interconnecting two lengths 128 of profiled section each with a bead 124 on one side. In this instance though the two lengths 128 of the side frame are opposite handed to accommodate for instance an inwardly opening part of the frame. Side openings 130 are provided on one side of each of the ends of the side lengths 128 to permit inserts 132 therein to connect to an insert 134 in the end of the transom/mullion part 122, as well as the inserts 132 in the two side lengths 128 permitting interconnection to mount together the two lengths 128 of the side frame. Here therefore three parts of the frame are simultaneously brought together following heating of the inserts 132, 134, to provide an arrangement as shown in FIG. 16.

There are thus described a number of arrangements permitting hollow elongate members to be interconnected by welding together inserts located within the hollow elongate members, and protruding to a short degree thereoutof. Using such inserts provides for a strong and clean joint whilst not requiring extra work in cleaning of the joint to remove excess material such as could be caused by welding both the elongate members together directly.

It is to be realised that the invention can be used in a number of other forms. For instance, the inserts may be adhered to each other using appropriate adhesive rather than using heat. In this instance the amount that the inserts protrude from the extrusion is likely to be reduced to a very small amount, and the inserts may be chosen to be sufficiently flexible such that the elongate members can be fully moved together.

With the method of the invention, elongate members of different materials such as for instance aluminium, could be interconnected. This method could be used for example with wooden or other frames, and if the frames are solid, recesses could be provided in the ends of respective elongate members to receive the inserts.

Whilst the above described examples relate to using two or more separate inserts which are brought together, the method also covers using a single insert extending between two hollow elongate members to interconnect same. The insert may be profiled, and could for example be L shaped to perpendicularly mount together the elongate members. Whilst the invention has been described in terms of a frame and especially a window frame, such a method can be used to mount together a wide range of different items.

It is to be realised that a range of other modifications may be made without departing from the scope of the invention. For example, different formations could be provided on the inserts and/or on the interior of the hollow members to retain the inserts in the hollow members. The inserts may be mounted in the elongate members other than by friction, for example fastening means such as screws or otherwise could be used.

The inserts may have any appropriate profile dependent on the internal profile of the respective hollow member. Whilst above inserts with ends extending at 45° or 90° to the longitudinal direction have generally been described, other angles could be used if required. Different materials could be used for the inserts. The inserts may have a wide range of profiles, as generally dictated by the members being joined.

It is also to be realised that any combination of the above features may be provided as required.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method of connecting two profiled hollow members, each profiled hollow member comprising a plurality of chambers, the method comprising: locating separate inserts in the interior of each hollow member, where each insert comprises a plurality of projections, which projections locate in the respective chambers of the profiled hollow member which the insert is located into; and
joining the separate inserts together to interconnect the two profiled hollow members.

2. The method according to claim 1, in which one of the inserts is inclined relative to the other insert, so as to connect the first and second hollow members inclined relative to each other, wherein the inserts joined together are substantially L shaped so as to perpendicularly interconnect the hollow members.

3. (canceled)

4. The method according to claim 1, in which the respective inserts are adhered to each other to interconnect the hollow members.

5. The method according to claim 1, in which the respective inserts are fused together by heating the inserts, wherein the inserts are heated in the two hollow members, and subsequently brought together with the inserts still hot such that they fuse together.

6. (canceled)

7. (canceled)

8. The method according to claim 1 in which an opening is cut in the second hollow member to enable the insert of the second hollow member to be located therein, to join to the insert located in the end of the first hollow member.

9. (canceled)

10. The method according to claim 1, in which the insert(s) are profiled.

11. The method according to claim 1, in which formations are provided on the insert(s) and/or hollow member(s) to retain the insert(s) in the interior of the hollow member(s).

12. The method according to claim 1, in which the hollow member(s) each comprise lengths of profiled sections, wherein the hollow members(s) are formed by extrusion, wherein the insert(s) are profiled to fit within the hollow members(s), wherein the inserts(s) are profiled to proved a friction fit within the hollow member(s), wherein the profiled section comprises the plurality of chambers, wherein the insert(s) comprise a base which locates at least initially outside of the hollow member and the plurality of projections extending from the base.

13-17. (canceled)

18. The method according to claim 1, in which edges of the insert(s) are chamfered or otherwise profiled to avoid overlapping edges of the hollow member(s).

19. The method according to claim 1, in which initially the inserts protrude from the hollow members, and the hollow members are brought together to immediately adjacent each other such that the inserts are substantially not visible.

20. (canceled)

21. The method according to claim 1, in which the hollow members are elongate and extend perpendicularly to each other.

22. The method according to claim 21, in which ends of the elongate members are inclined to provide a mitered joint therebetween, wherein the ends of the insert(s) are inclined.

23. (canceled)

24. The method according to claim 1, wherein the members are elongate, and extend perpendicularly to each other and the interconnection of the two members is formed between an end of a first one of the members and a location on a second one of the members which is intermediate the ends thereof.

25. The method according to claim 24, wherein the end of the first hollow member, and/or a side part of the second hollow member are cut so as to provide a substantially flush connection between the first and second hollow members.

26-28. (canceled)

29. The method according to claim 1, in which the hollow member(s) are formed by forming a recess in at least an end part of a solid member.

30. The method according to claim 1, in which the hollow member(s) are made of a plastics material.

31. (canceled)

32. The method according to claim 1, in which the hollow member(s) are made of metal.

33. (canceled)

34. (canceled)

35. The method according to claim 1, in which the insert(s) are made of a plastics material.

36. (canceled)

37. A method of forming a frame, the method comprising connecting together a plurality of frame members using a method according to claim 1.

38. (canceled)

39. A frame made by a method according to claim 1.

40-43. (canceled)
